(19) United States
(12) Patent Application Publication
(10) Pub. No.: US 2024/0152881 A1
(43) Pub. Date: May 9, 2024

(54) METHOD AND SYSTEM FOR ISOLATING TRANSACTION NODES IN A DECENTRALIZED COMPUTING ENVIRONMENT

(71) Applicant: Eleox LLC, Houston, TX (US)

(72) Inventors: James YU, Houston, TX (US); Rebecca GOTTSEGEN, Houston, TX (US); Don SPANKUCH, Houston, TX (US)

(21) Appl. No.: 17/983,121

(22) Filed: Nov. 8, 2022

(51) Int. Cl. G06Q 20/06; G06Q 20/40; H04L 9/40

(52) U.S. Cl. CPC G06Q 20/06; G06Q 20/405; H04L 63/20

(57) ABSTRACT

A distributed computing platform for isolating transaction nodes for managing energy post-trade processing. Plural participant computing systems each have a participant node module which executes a participant node on a decentralized computing network executing a smart contract in accordance with a decentralized protocol over a communication network. A reconciling computing system includes a reconciling module, a master database, a reconciling node module, and a reconciling distributed ledger interface module configured as an interface between the reconciling node module and other modules of the reconciling computing system. The reconciling node module is a node on the decentralized computing network. The reconciling computing system defines a domain of participant nodes on the decentralized computing network for each specific transaction which have access to trade data.

### BACKGROUND

“Commodities trading” typically refers to trading futures contracts, derivatives, and the like, related to energy products (e.g., crude oil, natural gas, and gasoline), metals, livestock, or agricultural products. Centuries ago, commodities trading was as simple as, for example, trading a specified number of bails of wheat for a specified number of pounds of copper. As one example, in Sumer (which is in modern day Iraq), clay tokens sealed in a clay vessel were used as a medium of exchange for livestock. The number of clay tokens inside each sealed vessel were inscribed in a stone tablet. A merchant would deliver the specified number of animals in exchange for each vessel. See, Origins of Growing Money, forbesindia.com/printcontent/34515.

In modern times, commodities contracts have become very complicated and are currently traded on computer platforms known as “commodities exchanges”. Notwithstanding the automation and recordkeeping advances offered by computing systems, current commodities exchanges are very inefficient because they require each party to maintain their own set of data and to periodically reconcile their set of data with sets of data for the other parties. This is especially true for energy commodities, such as natural gas, which must be physically transported and managed through a complex system of pipelines and other physical transportation mechanisms.

Natural gas pipelines, also known as “Transportation Service Providers (TSP)” can provide transportation that is “firm”, i.e., offered on a guaranteed basis (possibly with some exceptions/conditions). A TSP can also provide “interruptible” service, i.e., where the TSP has the right to cease a transportation service with little or no notice, for example to serve a higher priority customer/shipper. Of course, firm service is generally at a higher cost than interruptible service. Further, a TSP may include a pooling service (which allows aggregation of natural gas from multiple points of receipt), a parking service (which allows a customer/shipper to request a hold delivered quantities of natural gas on behalf of a specific customer/shipper), and a loan service (which allows a customer/shipper to receive natural gas quantities from the TSP and later return the quantities to the TSP at the point at which it was borrowed). To provide these services, it is necessary that the TSP controls a complex system of various infrastructure components, such as storage tanks, IT systems, valves, and the like.

Further, natural gas trades can represent complex transactions with various physical and business components. An “operational agreement” is an agreement, between a TSP and parties at delivery and/or receipt points, for specified balancing between desired levels of service and actual quantities of natural gas to be delivered. A “predetermined allocation agreement” designates the method for allocating natural gas amongst shippers. The physical nature of natural gas and the above-noted physical and business requirements make the trading of natural gas and other energy commodities far more complex than general trading of financial derivatives.

To address some of these complexities, physical natural gas trading uses a process known as “nomination”. A nomination is a request to move gas from one location to another under a specific contract with a pipeline. Nominations can indicate points of receipt and delivery, the specific contract (e.g., a contract representing a buy/sell deal between two parties) under which the gas is to flow on the pipeline, the volume of gas to be moved and other parameters for the physical movement of the gas and the financial transaction governing the physical movement. A nomination can be sent from two contracting parties to a pipeline scheduling platform, which confirms the upstream source and the downstream recipient to ensure that the nomination matches gas that the pipeline will receive from or deliver to the parties. If demand for service along a specific path exceeds capacity, rules can be applied by the scheduling platform to schedule nominations. After all nominations have been scheduled, nominations are confirmed back to the contracting parties, who must reconcile scheduled confirmation of the nomination with their internal records. For example, it is well known to use an Energy Trading Risk Management (ETRM) system for an entity to manage energy trades, schedules and invoices. An ETRM system includes a database of trade, schedule and invoice data. Each party to a trade typically will have their own ETRM system and can reconcile the data in their ETRM with the data of a counter party and pipeline.

Further, unlike many securities transactions conducted using a computerized marketplace where bids and asks are matched by an automated matching engine, natural gas trades are ordinarily contracted in a bilateral manner between a specific buyer and a specific seller. This renders it difficult to efficiently integrate the contracts into a computerized exchange. Therefore, notwithstanding the use of computer systems by each party, processes are often manual, communication between market participants is inefficient, and any changes interrupt the process and/or cause duplication of effort. In 2000, industry leaders came together to create the Intercontinental Exchange (ICE) to provide clearing and risk management services across a diverse range of regulated markets. However, the energy trading industry continues to operate with bespoke systems which limits transparency for post-trade transactions.

Many recent technologies, such as blockchain and other decentralized computing architectures, hold promise for increasing efficiencies in many computing tasks, including commodities trading. Decentralized computing platforms utilize cryptographic techniques and shared ledger copies to provide “trustless” data transactions between parties, i.e., transactions without the need for a trusted centralized party, such as a bank, government regulator, or the like. However, known decentralized computing environments are not readily adapted to use for commodities trading, and natural gas trading in particular, because of concerns around privacy and security of data shared across ledgers.

### SUMMARY OF THE INVENTION

The disclosed implementations provide a hybrid decentralized/centralized computing environment in which parties to a trade can be isolated and communicate in a peer-to-peer secure manner over a decentralized network while maintaining communications with other systems such as trade management risk systems and transportation systems. The disclosed implementations provide privacy, extensibility, interoperability and flexibility.

A first aspect of the invention is distributed computing system for isolating transaction nodes in a decentralized computing platform for energy post-trade processing, the platform comprising: a plurality of participant computing systems, each participant computing system including a participant node module and an interface between the participant node module and other modules of the participant computing system, wherein the participant node module executes a participant node on a decentralized computing network executing a smart contract in accordance with a decentralized protocol over a communication network; a reconciling computing system including a module, a master database, a reconciling node module, a reconciling distributed ledger interface module configured as an interface between the reconciling node module and other modules of the reconciling computing system, wherein the reconciling node module is a node on the decentralized computing network, the reconciling computing system further including a domain module configured to define a domain of participant nodes on the decentralized computing network which can participate in a specific transaction specified by the reconciling module and access data in the master database related to the specific transaction, the domain of participant nodes being a subset of the participant nodes on the decentralized computing network; and an authorization service configured to provide authorization for users on the participant computing systems with authorization for use by the domain module and ledger.

### BRIEF DESCRIPTION OF THE DRAWINGS

The foregoing summary, as well as the following detailed description of the invention, will be better understood when read in conjunction with the appended drawings. For the purpose of illustrating the invention, there are shown in the appended drawings various illustrative embodiments. It should be understood, however, that the invention is not limited to the precise arrangements and instrumentalities shown. In the drawings:

FIG. 1 is a block diagram of a hybrid computing architecture of a commodities trading platform in accordance with disclosed implementations.

FIG. 2 is a schematic representation of primary processes of a commodities trading platform in accordance with disclosed implementations.

FIG. 3 is a data flow diagram of data management functions of a commodities trading platform in accordance with disclosed implementations.

FIG. 4 is a data flow diagram of pairing engine functions of a commodities trading platform in accordance with disclosed implementations.

FIG. 5 is a data flow diagram of nomination engine functions of a commodities trading platform in accordance with disclosed implementations.

FIG. 6 is a data flow diagram of pipeline settlement engine functions of a commodities trading platform in accordance with disclosed implementations

FIG. 7 is a data flow diagram of customer settlement engine functions of a commodities trading platform in accordance with disclosed implementations.

### DETAILED DESCRIPTION

Implementations disclosed herein manage the transacting and transport of commodities, such as natural gas, in a manner that is far more efficient as compared to conventional platforms and processes. Disclosed implementations include a centralized distributed computing platform integrated with a distributed ledger in a manner that isolates transaction nodes for increased efficiency and security of commodities trading.

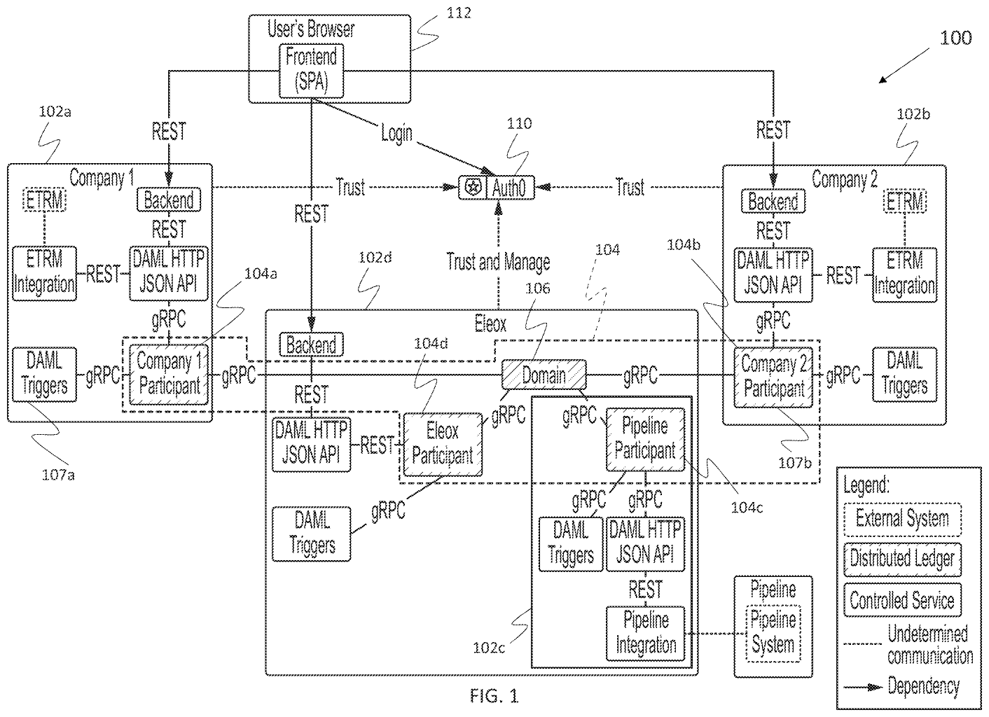

FIG. 1 illustrates an architecture of a hybrid computing platform 100 in accordance with disclosed implementations. Platform 100 includes participant computing platforms 102a and 102b, each associated with a participant entity. Note that the term “participants” or “company”, as used herein, refers to parties (i.e., entities) who accomplish commodities trades, such as natural gas trades, using platform 100. Such parties include, for example, the counterparties to a buy/sell trade, one or more pipeline entities and a reconciling entity. In the examples below, participant computing platforms 102a and 102b can be associated with counterparties in a buy/sell trade (Company 1 and Company 2 respectively). Of course, there can be any number of possible counterparties, but only two are shown in FIG. 1 for the sake of simplicity.

Each participant platform, for example 102a and 102b, can include an associated node on a decentralized distributed ledger network, such as a blockchain network 104 (shown schematically in the dashed box). In FIG. 1, participant node 104a is associated with participant platform 102a, participant node 104b is associated with participant platform 102b, and pipeline participant node 104c is associated with a pipeline participant platform 102c. Note that there can be any number of pipeline participants, but only one is shown for the sake of simplicity. Further, participant platform 102d is associated with a trade reconciling entity and includes participant node 104d. Each participant computing platform can also include various backend systems and interfaces. For example, participant platforms 102a and 102b each include a respective ETRM system and various interfaces. Participant platform 102c includes, for example, an interface/integration to a pipeline system. Note that participant platform 102d also includes domain module 106 which defines a relevant domain of nodes on the distributed ledger for transactions and ensures that each node executes the proper business logic through “triggers” described below. The function of domain module 106 is described in more detail below.

Each participant platform can include a corresponding set of triggers which define business and processing logic. Triggers can be expressed in DAML, for example. DAML “Digital Asset Markup Language” is an open-source smart contract language that enables developers to code multi-party business processes for a variety of database architectures. Other languages can also be used to define triggers in the disclosed implementations. Simplified pseudocode for an example of a trigger that pairs deals based on comparing deal parameters is set forth below. In this example, the trigger takes a company (participant) and their active deals in the ledger (ACS=Active Contract Set) and runs it against a rule (dealMatchingRule). The rule has logic to find/filter matched rules and creates a deal confirmation contract.
Query for all deals in the ACS relating to the company
Filter through deals for inbound deals (deal is for that company and the deal status is unpaired)
Filter through deals for outbound deals (deal is not for that company and the deal status in unpaired)
Compare the metadata of the two sets (inbound/outbound) and find pairs that meet equal criteria, creating a matched deal set
For every matched deal in the set, create a deal confirmation

Note that, in FIG. 1, platform 102c is shown logically as being part of platform 102d. However, this is not required and, for example, platform 102c could be distinct from platform 102d and could be controlled by a pipeline entity.

User terminal 112, can include a general-purpose, computing device, such as a personal computer, executing a web browser or other interface to provide access to and control of the relevant system by an authorized user (e.g., a person or an entity). Of course, there can be more than one user terminal 112. In most implementations, each participant will have at least one user terminal 112.

Authorization service 110, a JSON Web Token Service for example, serves to authorize each party's individual user and service accounts for various transactions and other activities. For example, the Auth0 service can be used for authorization service 110.

Each ledger contract can be processed (e.g., created, updated, and/or archived) with role-based security based on the designations of “Signatory”, “Observer”, and “Controller”. Signatories are the parties who must consent to the creation of a contract on the ledger, holding a position of obligation when a contract is created. Observers are additional stakeholders. A given contract is visible to Observers. A Controller is a party (usually also a signatory or observer) that can exercise a choice, or action, as part of the contract.

Each node has its own ledger on the decentralized platform that enforces security by only allowing valid tokens to access data on the node ledger. Each of platforms 102a, 102b, 102c, and 102d can also include various interfaces. For example, platforms 102a and 102b can each include a DAML HTTP JSON API which provides a Representational State Transfer (REST) API interface to provide a communications interface between various company backend systems (e.g., an accounting system) and a company ETRM. Platforms 102c and 102d can each include a similar interface to provide communications with relevant backend systems. The interface allows the hybrid architecture to leverage data from the distributed ledger for various processes by each participant while isolating data amongst only relevant participants in the manner described below.

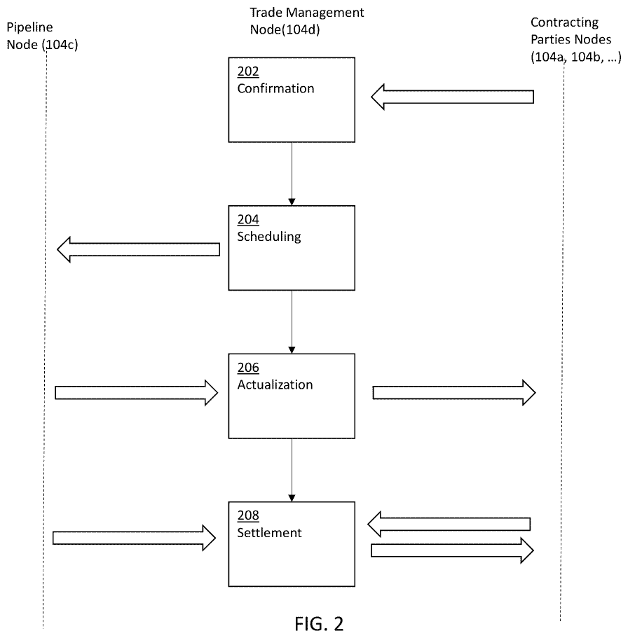

FIG. 2 illustrates the primary processes accomplished by platform 100 and the participants to each process, at a very high level. The primary processes include confirmation 202, scheduling 204, actualization 206, and settlement 208.

Confirmation process 202 includes receiving deal information from counterparties and pairing relative deals to each other. Deals can be cross-checked by both counterparties and reconciled as necessary. In the confirmation process, after deals are made between traders (i.e., counterparties), the deal is sent from each counterparty's node to the reconciling computing system node. As deal information is received from all counterparties, a pairing engine function (i.e., a deal trigger) will begin pairing the deals. If there are discrepancies between counterparty deals, the pairing engine function can be applied to manage discrepancies and communicate with respective counterparties. Once all values are aligned between both counterparties, the deal is confirmed and marked as paired. All finalized values will be pushed back to both counterparties via their respective nodes on the decentralized network as described in more detail below.

The scheduling process 204 starts with or without a deal confirmation. Nominations can be created without a deal. Deals are executed via a single nomination or multiple nominations that are sent to the respective pipelines to deliver the natural gas. Schedulers need to be aware of their capacity on each pipeline and their positions in trade zones.

In scheduling process 204, schedulers plan all the nominations for a period of time (e.g., the next month). For additional context, one nomination can span an entire month and represent how much natural gas flows daily throughout the month. For example, nomination A could last 30 days and is planned to ship 10,000 MMBtu of natural gas each day. Schedulers will use a nomination engine (described below) to manage their nominations after they are pulled in from a corresponding participant ETRM via the participant node or through another upload mechanism. Schedulers will also have the ability to create nominations using a standardized nomination engine accounting for multiple pipeline nomination model types. The model types can include Pathed, Pathed Non-Threaded, Non-Pathed Non-Threaded.

Once nominations are stored on the platform, the nomination attributes will be validated with other on-system participant's nominations. Schedulers will be able to tie nominations to their respective deals and be able to view critical KPIs that will improve how they plan and manage balances on the pipeline, balances against counterparties, and contracts. Schedulers will also be able to communicate with their respective counterparties and manage any discrepancies within the nomination engine. The nomination engine will also automatically update nominations based on their most recent volume from the pipeline, further reducing the manual effort of schedulers having to manually identify cuts and update nominations.

In the actualization process 206, for example at the end of a pipeline's monthly schedule, pipelines share a final flow statement to natural gas shippers that details how much actual volume was delivered and the respective transportation fuel charges needing payment. The reports from the pipeline represent what flowed on the pipeline, and the actualization analyst can confirm the flow report with what the scheduler entered in the nomination. Nominations that have a discrepancy with the flow report can be flagged and a corresponding notification can be sent to the actualization analyst for review.

All information from a pipeline can be transmitted through the node corresponding to the pipeline to relevant participants designated by the domain module. Alternatively, the nomination engine can leverage an HTTPS REST API using Electronic Data Interchange (EDI) messaging standards to get updated volume data directly from the pipeline. Disclosed implementations can receive nomination “cuts” (adjustments) from the pipeline as a scheduled volume change. These changes will be reflected on the company's ledger and a pairing engine function (i.e., a volume trigger) will validate the other participant's ledger on its node and will have the same scheduled volume change from the nomination cut. Further, triggers can validate ledgers of all relevant parties in a chain of transactions relating to the nomination. In comparison, in conventional systems, if the nomination is flagged as having a discrepancy, the nomination will be added to a queue for manual review by the parties involved in the deal or nomination, which can include a chain of parties in a transaction.

The settlement process 208 on platform 100 can begin, for example, at the end of each month. At this point, nomination volumes have been actualized, and pipeline invoices are received. The participant's draft pipeline invoice data will be pulled from the participant's ETRM to the participant's node. Alternatively, participants can upload their pipeline invoice data for cross-checking via another mechanism (e.g., a spreadsheet). The pipeline invoice data from the pipeline is transferred to the participant's platform via EDI (or the pipeline's own node), which triggers a settlement engine to process the pipeline invoice against the participant's invoice data based on the triggers. Users can view any discrepancies between their pipeline invoice data and the pipeline invoice and correct any discrepancies in their corresponding ETRM. The settlement engine again compares the corrected discrepancies to resolve issues. Once values are settled on-platform, the finalized data will be pushed to the participants' nodes for updates and counterparty settlement.

Reconciling computing system 102d can categorize transactional data as a combination of static and reference data (both described below). Given the underlying decentralized technology and triggers, a company's specific transactional data will not be visible to reconciling computing system 102d or other companies on the platform. For example, deals have corresponding data have records such as “buyerCounterparty,” “sellerCounterparty,” and “settlementFrequency.” If “Company A” does a buy deal with “Company B,” and thus “Company B” does a sell deal with “Company A.” The deals data would be specific to the company and in their platform format and language. When these deals are in reconciling computing system 102d, there is an underlying algorithm to pair these buy and sell deals based on data fields. Platform-specific fields are translated into the respective enums to match the specification reference data.

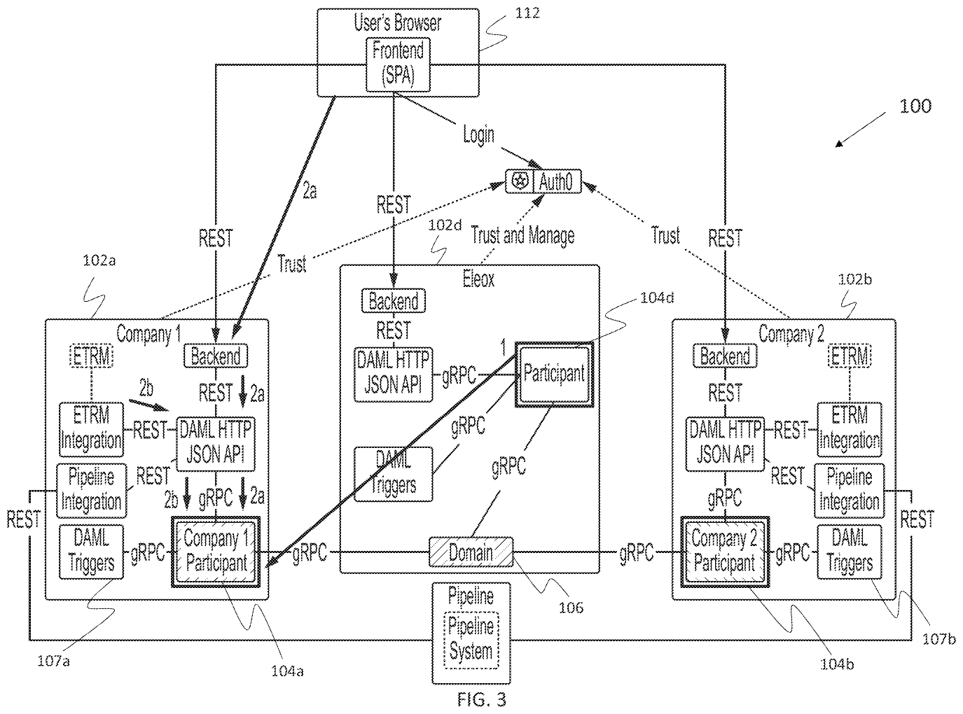

FIG. 3 illustrates the data management aspects of platform 100. Elements of FIGS. 3-6 are similar to corresponding elements in FIG. 1 Note that FIGS. 3-6 have been simplified and do not illustrate the pipeline node for purposes of simplicity. In FIGS. 3-6, the pipeline entity is shown as communicating with the reconciling computing system through EDI or another conventional protocol. Reconciling computing system 102d maintains a master data set that will be available for each node to observe based on permissions. The master data set may have a data structure/model as set forth in the chart below.

| Template | Signatory | Controller | Observer | Choice |
|---|---|---|---|---|
| CounterpartySpec | Reconciling | | Node1, | Create and Archive |
| | computing system | | Node2 | |
| PipelineSpec | Reconciling | | Node1, | Create and Archive |
| | computing system | | Node2 | |
| ZoneSpec | Reconciling | | Node1, | Create and Archive |
| | computing system | | Node2 | |
| LocationSpec | Reconciling | | Node1, | Create and Archive |
| | computing system | | Node2 | |
| InterconnectSpec | Reconciling | | Node1, | Create and Archive |
| | computing system | | Node2 | |
| RateSchedulesSpec | Reconciling | | Node1, | Create and Archive |
| | computing system | | Node2 | |
| RateDefinitionsSpec | Reconciling | | Node1, | Create and Archive |
| | computing system | | Node2 | |
| LocationGroupsSpec | Reconciling | | Node1, | Create and Archive |
| | computing system | | Node2 | |
| PayIndexTypesSpec | Reconciling | | Node1, | Create and Archive |
| | computing system | | Node2 | |
| ProviderChargeTypesSpec | Reconciling | | Node1, | Create and Archive |
| | computing system | | Node2 | |
| TransactionTypesSpec | Reconciling | | Node1, | Create and Archive |
| | computing system | | Node2 | |

The Domain Module 106 manages and validates that each participant node is working with the same distributed ledger and triggers. When a participant's distributed ledger changes (e.g., a new deal is entered), the participant's trigger 107a and 107b will trigger using the validation rules defined by the triggers. The triggers will define roles (e.g., Signatory(s), Controller(s), and Observer(s)) for each element in the distributed ledger. The Domain Module 106 will review the trigger logic and route traffic to the specific participant nodes, and only those nodes that have been granted access to the data.

With reference to FIG. 3, participants observe the data, based on access granted by domain module 106 (by being designated as Observers), and each create mapping contracts on their respective node 104a and 104b. As shown at 104d, a participant node can use the observed master data set called “spec data”. The data can then be accessed by the participant through the corresponding API module of the participant and viewed on the user interface of user device 112. As shown at 104d, the Observer participants can then map the data to their internal systems, such as an ETRM system of the participant. The data can be saved on a template ledger of the corresponding nodes 104a and 104b. An example of the data sets of the mapped contracts are set forth in the chart below.

| Template | Signatory | Controller | Observer | Choice |
|---|---|---|---|---|
| Counterparty | Node1 | Node1 | | Create, Update, and Archive |
| Pipeline | Node1 | Node1 | | Create, Update, and Archive |
| Zone | Node1 | Node1 | | Create, Update, and Archive |
| Location | Node1 | Node1 | | Create, Update, and Archive |
| Interconnect | Node1 | Node1 | | Create, Update, and Archive |
| RateSchedules | Node1 | Node1 | | Create, Update, and Archive |
| RateDefinitions | Node1 | Node1 | | Create, Update, and Archive |
| LocationGroups | Node1 | Node1 | | Create, Update, and Archive |
| PayIndexTypes | Node1 | Node1 | | Create, Update, and Archive |
| ProviderChargeTypes | Node1 | Node1 | | Create, Update, and Archive |
| TransactionTypes | Node1 | Node1 | | Create, Update, and Archive |

At 1, a participant trading part (Company 1 in this example) will pull the “spec data” from 104d participant node, and map the data to their ETRM system. At 2a, Company 1 user will manually upload the mapping data in the user interface which will flow into the company's ledger. At 2b, Company 1 will setup an ETRM integration that will automatically sync changes in their ETRM system to their company's ledger.

Reconciling computing system 102d maintains predefined data values as enums (i.e., data types that enable for a variable to be selected from a set of predefined constants) to address inconsistencies of certain data field values among the various ETRM systems, and other systems, of participants. Before this data field value is sent from the ETRM to reconciling computing system 102d, it will have to conform to the predetermined enums standard for reconciling computing system 102d to accept the data field value. Enum data is visible to reconciling computing system 102d and other platforms. As an example, a participant's ETRM, may reference settlement frequencies as “Daily”, “Monthly”; “Day”, “Month”; “D”, “M”; or the like (all of which convey the same underlying semantics. Reconciling computing system 102d can set the standard enums for settlement frequencies as “Daily”, “Monthly”, “Quarterly”, “Yearly”. All ETRMs will be mapped to the enum definition for static data. The following are examples of enums can be defined in a similar manner:
Averaging Methods;
Charge Indicators;
Contract Types;
Currencies;
Deal Types
Delivery Types;
Flow Directions;
Location Categories;
Location Countries;
Location States;
Location Types;
Master Contract Types;
Periodicals;
Rate Types;
Trade Types;
Unit of Measures.

Additionally, the predefined enums can correspond to reference data based on industry standards, defined by the pipelines for example, to address inconsistencies of data among various ETRM systems. Before this reference data is sent from the ETRM to reconciling computing system 102d, the ETRM system should map this data to the specification reference data. This will ensure that each company, when interacting with the reconciling computing system 102d, will be able to view the reference data in their own ETRM language. In addition, each company would be able to align their reference data against the mapping they did to the specification reference data to have a single source of truth. Given the underlying decentralized technology and smart contracting language, the company's ETRM specific reference data will not be visible to reconciling computing system 102d or other companies on the platform. However, the specification reference data will be visible to the companies.

For example, the “Counterparties” data can have the fields “legal entity name” and “duns” that are based on a defined industry standard and allow for records to be uniquely identified. However, companies may have short names that are specific to their platform for these records. A company can map these short names to the specification reference data so that, when interacting with reconciling computing system 102d, the company can still interact with the products using the short names. The specification reference data for “counterparties” could indicate, for example, that the “legal entity name” is “BP Energy Company”. Another company's platform may have the short name as “BP,” “British Petroleum,” etc. However, all of these names would map to the same specification reference data.

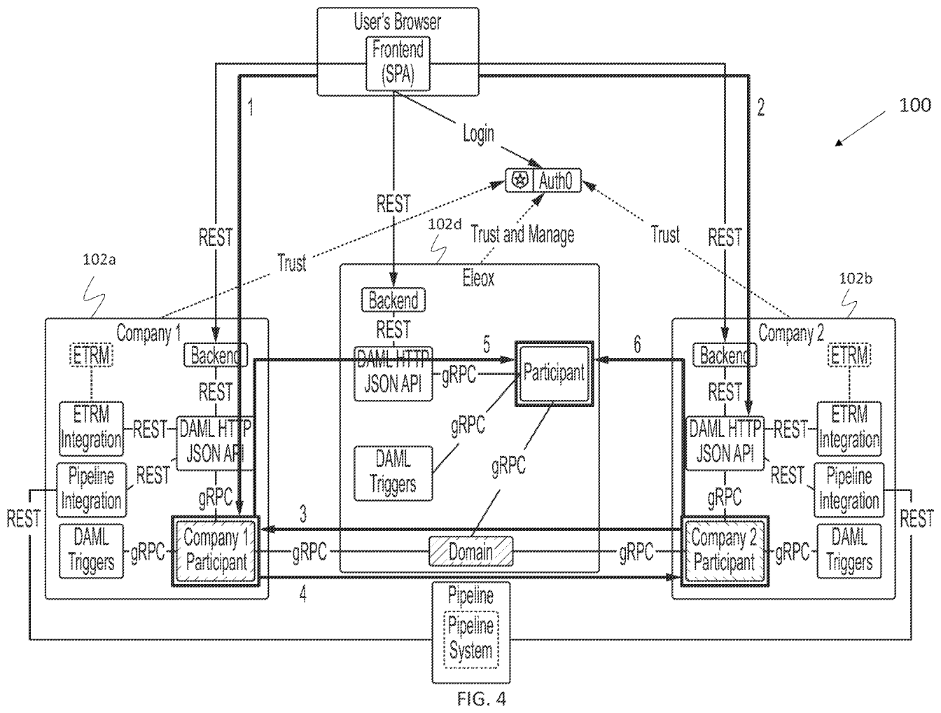

FIG. 4 illustrates the operation of the pairing engine function in accordance with disclosed implementations. At 1, a participant trading party (Company 1 in this example) submits deal information to their node, for example using a UI on their corresponding user device. In this example, Company 1 (node 104a) has a buy deal with Company 2 (node 104b). At 2, Company 2 submits the deal information to their node. Company 2 has a sell deal with Company 1 in this example. While only one user device is illustrated, it is clear that each party could have their own user device(s). At 3, the node of Company 1 observes the sell deal information of Company 2, pairs deal attributes, and creates a contract for the deal pair. At 4, the node of Company 2 observes the buy deal information from the node of company 1.

Note that the observations can be accomplished in a peer-to-peer manner because, as described above, the nodes are on a distributed ledger. Also, as described above, observation is permitted by the domain module by designating a subset of nodes that are relevant to the deal. Node 2 also pairs deal attributes and creates a contract for the deal pair. At 5, the node of Company 1 sends a deal ID and confirmation status to the node of the reconciling computing system. At 6, the node of Company 2 sends a deal ID and confirmation status to the node of the reconciling computing system to complete the pairing process. By receiving confirmation from Company 1 and Company 2, the reconciling computing system is able to successfully verify that both parties have paired their deals. An example of a pairing data schema is set forth below.

Trade Date
Buyer
Seller
Broker
Delivery Start Date
Delivery End Date
Delivery Type
Pipeline
Pipeline Delivery/Meter
Location
Quantity
Total Quantity
Quantity Unit
Quantity Frequency
Fixed Price
Pricing Frequency
Price Precision
Price Currency
Price Unit
Settlement Currency
Settlement Frequency
Buyer Pay Index
Index Averaging Method
Index Calendar
Index Differential
Contract Date
Master Contract Type

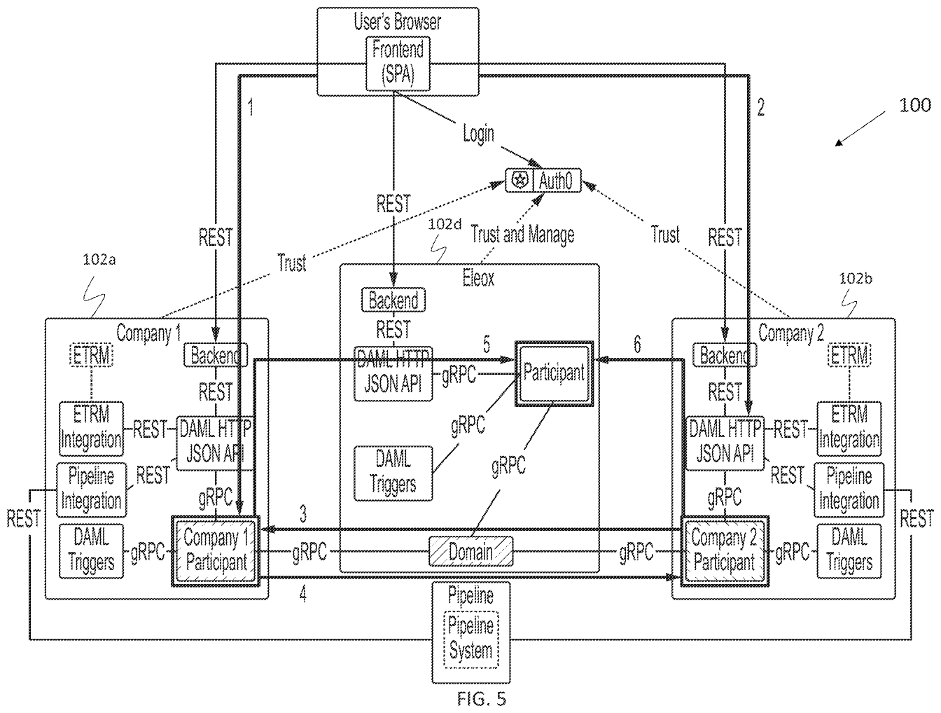

FIG. 5 illustrates the operation of the nomination engine that reconciles scheduled volumes for each participant node. The nomination engine function replaces the current process used by schedulers to maintain their nomination process either by using a spreadsheet or proprietary system. The reconciling computing system can submit the nomination details to a pipeline via EDI. Conventionally, schedulers do this by uploading spreadsheets to the pipeline via Electronic Bulletin Boards (EBB). The nomination engine of the disclosed implementations reconciles the nomination attributes (e.g., scheduled volumes) for the nomination between members that are on the platform. At 1, Company 1 submits nomination paths to its corresponding node. At 2, Company 2 submits nomination paths to its corresponding node. At 3, the node of Company 1 observes the supply information of node of Company 2, pairs nomination attributes and creates a contract for the nomination path. At 4, the node of Company 2 observes the demand information of the node of Company 1, pairs nomination attributes and creates a contract for the nomination path. At 5, the node of Company 1 sends a nomination ID and confirmation to the reconciling computing system node. At 6 the node of Company 2 sends a nomination ID and confirmation to the reconciling computing system node. The nomination ID and confirmation nomination path status can be stored in the master database of the reconciling computing system. By receiving confirmation from Company 1 and Company 2, the reconciling computing system is able to successfully verify that both parties have the same nomination path details in their systems.

The concept of “responsibly sourced gas” (RSG) has become well known recently. RSG is natural gas that an independent third party has verified as meeting specified practices for minimizing the environmental footprint of the gas production process. Assessment criteria for RSG can consider attributes of the production process such as methane emissions, water use, water quality, and land use. Various entities have assumed responsibility as certification authorities. However, there is no single accepted standard for certification of RSG. However, the certification authorities provide certificates for gas that conforms to their certification standards. Such certificates have become commercially valuable in many situations. The disclosed implementations provide for associating RSG certificates with any corresponding nomination and tracking the same throughout the process. The certificates can be associated with the nomination ID on the ledger i to allow the certificate to persist throughout the distribution process of the certified gas.

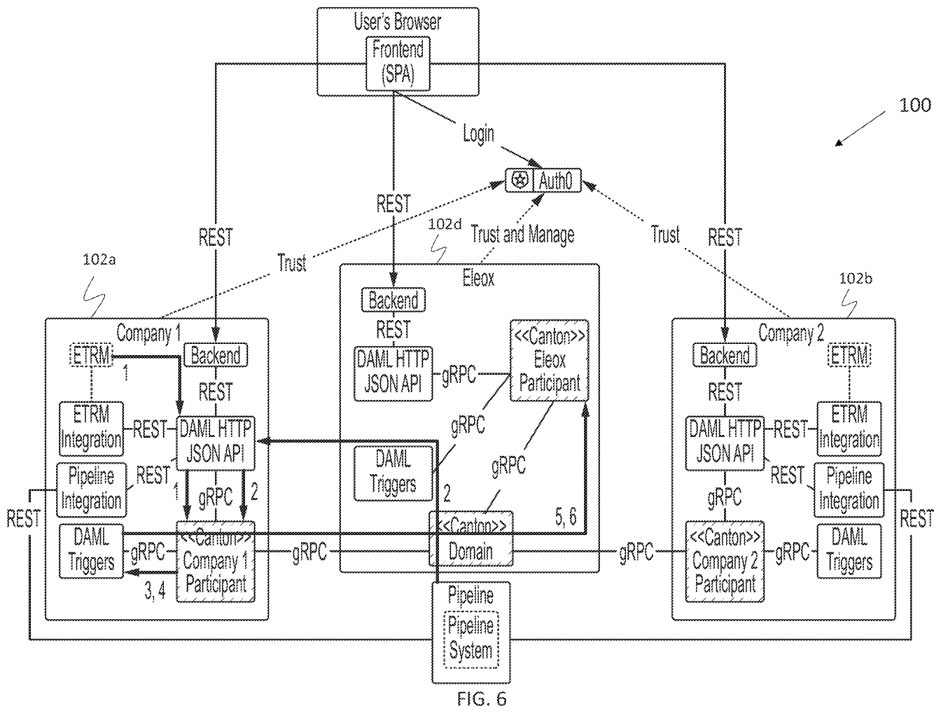

FIG. 6 illustrates a pipeline settlement function of a settlement engine in accordance with the disclosed implementations. The pipeline will publish actualized volumes after the actual flow of volume on the pipeline. The settlement engine will retrieve the pipeline invoice attributes via the pipeline EDI (or through the pipeline's own node) and pass the details of the pipeline invoice attributes to the appropriate ETRM system. At 1, Company 1 ETRM (or alternative mechanisms) submits its invoice data to Company 1's node. At step 2, the pipeline submits a pipeline invoice to node 1 through the API. Note that, in this example, the pipeline does not have a corresponding node on the distributed ledger and the pipeline can communicate with the computing platforms of participants through EDI or another conventional protocol. At 3, node 1 pairs the pipeline invoice with the invoice data from the ETRM, in accordance with a trigger, based on attributes of the invoices. At 4, a contract for the invoice pair is created. At 5, node 1 sends a confirmation of the contract to the reconciling computing system through the distributed ledger.

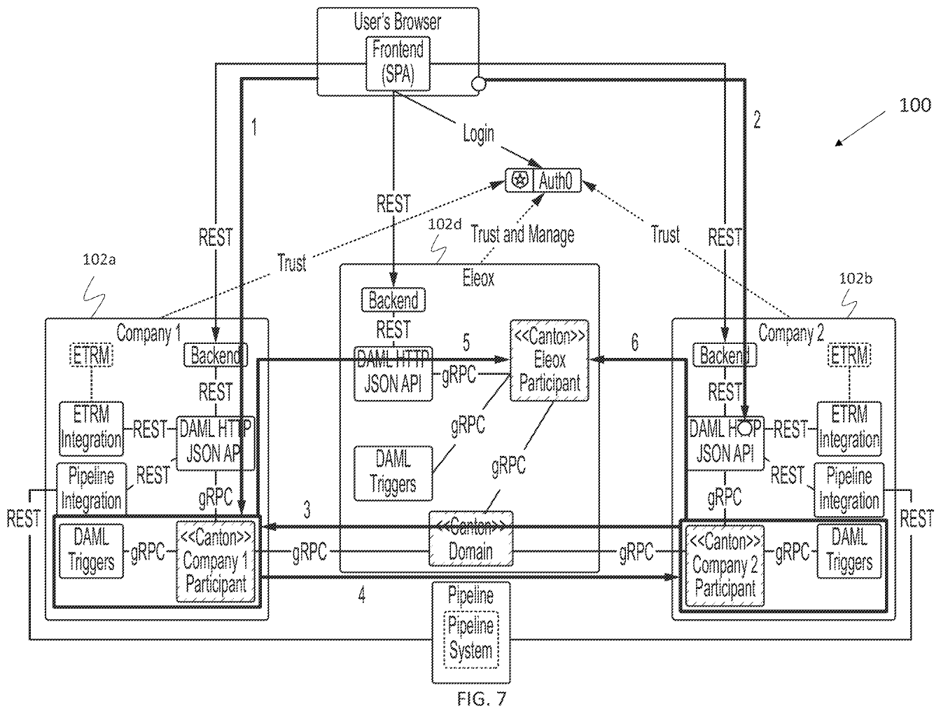

FIG. 7 illustrates a counterparty monthly settlement function of a settlement engine in accordance with disclosed implementations. At 1, Company 1 submits purchase invoice information from ETRM through the corresponding node. At 2, Company 2 submits sale invoice information through the corresponding node. At 3, the node of Company 1 observes the invoice data submitted by company 2, pairs invoice attributes and creates a corresponding contract. At 4, the node of Company 2 observes the invoice data submitted by Company 1, pairs invoice attributes and creates a corresponding contract. At 5, the node of Company 1 sends an invoice ID and a confirmation to the node of the reconciling computing system. At 6, the node of Company 2 sends an invoice ID and a confirmation to the node of the reconciling computing system. By receiving confirmation from Company 1 and Company 2, the reconciling computing system is able to successfully verify that both parties have the same counterparty invoice details in their systems. For example, the pairing data schema in the counterparty monthly settlement could be as set forth below:
Price
Volume
Point (location)
Flow date
Pipeline

The disclosed implementations allow the counterparties to operate on nodes that are isolated, and which can communicate in a peer-to-peer manner for reconciling data at the various stages of a commodities transaction. This eliminates the need for complex data checks and manual reconciliation which is prevalent in conventional systems and processes. The disclosed implementations eliminate much of the cross-checking and auditing required in conventional processes by providing isolated peer-to-peer communication between nodes associated with relevant participants and a shared ledger of relevant data. Further, the disclosed implementations maintain the isolation and deal flexibility of deal making required by parties contracting in commodities such as natural gas, carbon emissions, or power.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

1. A distributed computing system for isolating transaction nodes in a decentralized computing platform for energy post-trade processing, the platform comprising:
a plurality of participant computing systems, each participant computing system including a participant node module and an interface between the participant node module and other modules of the participant computing system, wherein the participant node module executes a participant node on a decentralized computing network executing at least one smart contract in accordance with a decentralized protocol over a communication network;
a reconciling computing system including a master database, a reconciling node module, a reconciling distributed ledger interface module configured as an interface between the reconciling node module and other modules of the reconciling computing system, wherein the reconciling node module is a node on the decentralized computing network, the reconciling computing system further including a domain module configured to define a domain of participant nodes on the decentralized computing network which can participate in a specific transaction specified by the reconciling module and access data in the master database related to the specific transaction, the domain of participant nodes being a subset of the participant nodes on the decentralized computing network; and
an authorization service configured to provide authorization for users on the participant computing systems.

2. The computing system of claim 1, wherein data in the master database is stored as normalized data in accordance with a standard schema.

3. The computing system of claim 2, wherein the platform is configured so that:
the domain of participant nodes includes a first participant node module corresponding to a first participant and a second participant node module corresponding to a second participant;
a first participant has a predefined buy/sell deal with the second participant and the second participant has a corresponding buy/sell deal with the first participant;
the first participant node module submits data relating the predefined buy/sell deal to the decentralized computing network and the second participant submits data relating the corresponding buy/sell deal to the decentralized network;
the first participant node module observes the data relating the corresponding buy/sell deal over the decentralized network and the second participant observes the data relating the corresponding data relating the predefined buy/sell deal over the decentralized network;
the first participant node module and the second participant node module create a pair between the data relating the predefined buy/sell deal and the data relating the corresponding buy/sell deal;
the first participant node module and the second participant node module each send a confirmation of the pair; and
the reconciling computing system stores the pair as a confirmed trade in the master database and the decentralized computing network.

4. The computing system of claim 2, wherein the platform is configured so that:
at least one of (a) the first participant node module submits supply/demand nomination path information to the decentralized computing network and (b) the second participant node submits supply/demand nomination path information to the decentralized computing network;
the first participant node module observes supply/demand nomination path information over the decentralized computing network and the second participant node observes the supply/demand nomination path information over the decentralized computing network;
the first participant node module and the second participant node module pair attributes of the supply/demand nomination path information and the supply/demand nomination path information;
the first participant node module and the second participant node module each send a confirmation of a nomination path pair; and
the reconciling computing system stores the nomination path in the master database and the decentralized computing network.

5. The computing system of claim 2, wherein the platform is configured so that:
actualized volume data corresponding to a deal is received from a pipeline computing platform;
a settlement module of the reconciling computing system, retrieves the pipeline invoice attributes via the pipeline EDI, or through a node module of the pipeline, and pairs the pipeline invoice with the participant's invoice data in a corresponding ETRM of the participant;
the first of the participant node modules corresponding to parties of the deal pulls invoice data from a corresponding ETRM system;
the first of the participant node modules corresponding to the parties of the deal receives an invoice from the pipeline;
the first of the participant node modules corresponding to the parties of the deal pairs the pipeline invoice with the invoice from the participant's invoice data and creates a first contract for the invoice pair; and
the first of the participant node modules corresponding to the parties of the deal sends a confirmation of the contract to the reconciling computing system through the distributed ledger and the reconciling computing system stores the confirmation of the contract in the master database and the decentralized computing network.

6. The computing system of claim 23, wherein the platform is configured so that:
at least one of (a) the first participant node module submits purchase/sale invoice information to the decentralized computing network and (b) the second participant node submits purchase/sale invoice information to the decentralized computing network;
the first participant node module observes the purchase/sale invoice information over the decentralized computing network and the second participant node observes the purchase/sale invoice information over the decentralized computing network;
the first participant node module and the second participant node module pair attributes of the purchase/sale invoice information and the purchase/sale invoice information;
the first participant node module and the second participant node module each send an invoice confirmation; and
the reconciling computing system stores the invoice confirmation in the master database and the decentralized computing network.

7. The computing system of claim 1, further comprising an interface module configured to provide communication with at least one external computing system of a participant computing platform.

8. The computing system of claim 7, wherein at least one external computing system of a participant includes an ETRM computing platform or a pipeline nomination lifecycle management system.

9. The computing system of claim 1, wherein the authorization service is a JSON Web Token Service.

10. The computing system of claim 4 wherein at least one certificate of “responsibly sourced gas” (RSG) is associated with the nomination path stored in the master database.

11. A computer implemented method for isolating transaction nodes in a decentralized computing platform for energy post-trade processing, the computing platform including:
a plurality of participant computing systems, each participant computing system including a participant node module and an interface between the participant node module and other modules of the participant computing system, wherein the participant node module executes a participant node on a decentralized computing network executing at least one smart contract in accordance with a decentralized protocol over a communication network; a reconciling computing system including a master database, a reconciling node module, a reconciling distributed ledger interface module configured as an interface between the reconciling node module and other modules of the reconciling computing system, wherein the reconciling node module is a node on the decentralized computing network, the reconciling computing system further including a domain module configured to define a domain of participant nodes on the decentralized computing network which can participate in a specific transaction specified by the reconciling module and access data in the master database related to the specific transaction, the domain of participant nodes being a subset of the participant nodes on the decentralized computing network and includes a first participant node module corresponding to a first participant and a second participant node module corresponding to a second participant; a first participant has a predefined buy/sell deal with the second participant and the second participant has a corresponding buy/sell deal with the first participant; and an authorization service configured to provide authorization for individual users on the participant computing systems with authorization for use by the domain module and ledger, the method comprising:
the first participant node module submitting data relating the predefined buy/sell deal to the decentralized computing network and the second participant submitting data relating the corresponding buy/sell deal to the decentralized network;
the first participant node module observing the data relating the corresponding buy/sell deal over the decentralized network and the second participant observing the data relating the corresponding data relating the predefined buy/sell deal over the decentralized network;
the first participant node module and the second participant node module creating a pair between the data relating the predefined buy/sell deal and the data relating the corresponding buy/sell deal;
the first participant node module and the second participant node module each sending a confirmation of the pair; and
the reconciling computing system storing the pair as a confirmed trade in the master database and the decentralized computing network.

12. The method of claim 11, wherein data in the master database is stored as normalized data in accordance with a standard schema.

13. The method of claim 11, wherein the method further comprises:
at least one of (a) the first participant node module submitting first supply/demand nomination path information to the decentralized computing network and (b) the second participant node submitting second supply/demand nomination path information to the decentralized computing network;
at least one of the first participant node module observing the second supply/demand nomination path information over the decentralized computing network and the second participant node observing the first supply/demand nomination path information over the decentralized computing network;
the first participant node module and the second participant node pairing attributes of the first supply/demand nomination path information and the second supply/demand nomination path information;
the first participant node module and the second participant node module each sending a confirmation of a nomination path pair; and
the reconciling computing system storing the nomination path in the master database and the decentralized computing network.

14. The method of claim 11, wherein the method further comprises:
at least one of (a) the first participant node module submitting purchase/sale invoice information to the decentralized computing network and (b) the second participant node submitting purchase/sale invoice information to the decentralized computing network;
the first participant node module observing the purchase/sale invoice information over the decentralized computing network and the second participant node observing the purchase/sale invoice information over the decentralized computing network;
the first participant node module and the second participant node module pairing attributes of the purchase/sale invoice information and the purchase/sale invoice information;
at least one of the first participant node module and the second participant node module each sending an invoice confirmation; and
the reconciling computing system storing the invoice confirmation in the master database and the decentralized computing network.

15. The method of claim 12, further comprising:
receiving actualized volume data corresponding to a deal from a pipeline computing platform;
retrieving, by a settlement module of the reconciling computing system, the pipeline invoice attributes via the pipeline EDI, or through a node module of the pipeline, and pairs it with the participant's invoice data in a corresponding ETRM;
pulling, by a first of the participant node modules corresponding to parties of the deal, invoice data from the corresponding ETRM system;
receiving, by the first of the participant node modules corresponding to the parties of the deal, a pipeline invoice from the pipeline
pairing, by the first of the participant node modules corresponding to the parties of the deal, the pipeline invoice with the invoice from the participant's invoice data and creating a first contract for the invoice pair; and
sending, by the first of the participant node modules corresponding to the parties of the deal, a confirmation of the contract to the reconciling computing system through the distributed ledger and the reconciling computing system stores the confirmation of the contract in the master database and the decentralized computing network.

16. The method of claim 12, further comprising storing at least one certificate of “responsibly sourced gas” (RSG) in the master database associated with the nomination path.
